(19) United States
(12) Patent Application Publication
(10) Pub. No.: US 2009/0144385 A1
(43) Pub. Date: Jun. 4, 2009

(54) Sequential Message Transmission System

(76) Inventor: Harry Gold, West Newton, MA (US)

Correspondence Address: ROBERT PLOTKIN, PC, 45 BUTTERNUT CIRCLE, CONCORD, MA, 01742-1937, US

(21) Appl. No.: 12/367,269

(22) Filed: Feb. 6, 2009

Related U.S. Application Data
(60) Provisional application No. 61/033,207, filed on Mar. 3, 2008.

(51) Int. Cl. G06F 15/16

(52) U.S. Cl. 709/206

(57) ABSTRACT

A computer system transmits a sequence of messages to multiple users. The first user subscribes to the sequence at a first time. In response, the system transmits each message in the sequence to the first user in sequence and at predetermined intervals (e.g., every month), beginning at the first user's subscription time. A second user subscribes to the sequence at a second time (e.g., a week after the first user's subscription time). In response, the system transmits each message in the sequence to the second user in sequence and at predetermined intervals (e.g., every month), beginning at the second user's subscription time. As a result, the system may transmit the same message in the sequence to different users at different times, and transmit different messages in the sequence to different users at the same time. Advertisements may be dynamically inserted within the messages based on their delivery times.

### CROSS REFERENCE TO RELATED APPLICATIONS

This application claims the benefit of U.S. Provisional Patent Application Ser. No. 61/033,207, filed on Mar. 3, 2008, entitled “Tip-Oriented Messaging Systems and Methods,” which is hereby incorporated by reference.

### BACKGROUND

Various technologies exist for delivering information to users over electronic communication networks. For example, companies often use email as a vehicle for transmitting advertisements, press releases, and promotional offers to existing and prospective customers. Furthermore, individuals and companies increasingly use email to transmit newsletters to lists of subscribers on a periodic basis, e.g., every month.

Such existing systems, however, have a variety of drawbacks. For example, when using conventional email newsletter services, once a particular issue of the newsletter has been sent to the newsletter's subscribers, that issue is not received by any other subscribers in the future unless the administrator of the newsletter takes some affirmative action to re-send that edition of the newsletter to the other subscribers. As a result, each issue of an email newsletter typically has a relatively short “shelf life” and loses its value, and its ability to generate revenue for its creator, shortly after it is transmitted. Although some existing systems provide the ability to archive issues of an email newsletter after they have been transmitted, such as by storing such issues on a web site, such archived issues are only viewed if subscribers manually visit the archive web site. As a result, the archived editions of the newsletter are likely to be underutilized.

### SUMMARY

A computer system transmits a sequence of messages to multiple users. The first user subscribes to the sequence at a first time. In response, the system transmits each message in the sequence to the first user in sequence and at predetermined intervals (e.g., every month), beginning at the first user's subscription time. A second user subscribes to the sequence at a second time (e.g., a week after the first user's subscription time). In response, the system transmits each message in the sequence to the second user in sequence and at predetermined intervals (e.g., every month), beginning at the second user's subscription time. As a result, the system may transmit the same message in the sequence to different users at different times, and transmit different messages in the sequence to different users at the same time. Advertisements may be dynamically inserted within the messages based on their delivery times. The system provides a significant degree of flexibility in sequencing messages within a message list, changing that sequence, and adding messages to and deleting messages from such a list.

For example, one embodiment of the present invention is directed to a computer-implemented system or method comprising: (A) identifying a first system delivery time; (B) identifying a first user delivery time associated with a first user; and (C) if the first system delivery time is equivalent to the first user delivery time, then: (C)(1) identifying a first message sequence identifier associated with the first user; (C)(2) identifying first message content associated with a first message content sequence identifier having a value equivalent to a value of the first message sequence identifier; and (C)(3) providing the first message content to the first user.

Other features and advantages of various aspects and embodiments of the present invention will become apparent from the following description and from the claims.

### BRIEF DESCRIPTION OF THE DRAWINGS

FIG. 1 is a system for subscribing a user to a sequence of electronically-delivered messages, such as a sequence of “tips” on a particular topic delivered by email over the Internet, according to one embodiment of the present invention;

FIG. 2 is a flowchart of a method performed by the system of FIG. 1 according to one embodiment of the present invention;

FIG. 3 is a dataflow diagram of a system for transmitting message sequences to subscribers according to one embodiment of the present invention;

FIG. 4 is a flowchart of a method performed by the system of FIG. 3 according to one embodiment of the present invention;

FIG. 5 shows a dataflow diagram of a system for displaying a message to a subscriber according to one embodiment of the present invention; and

FIG. 6 shows a flowchart of a method performed by the system according to one embodiment of the present invention.

### DETAILED DESCRIPTION

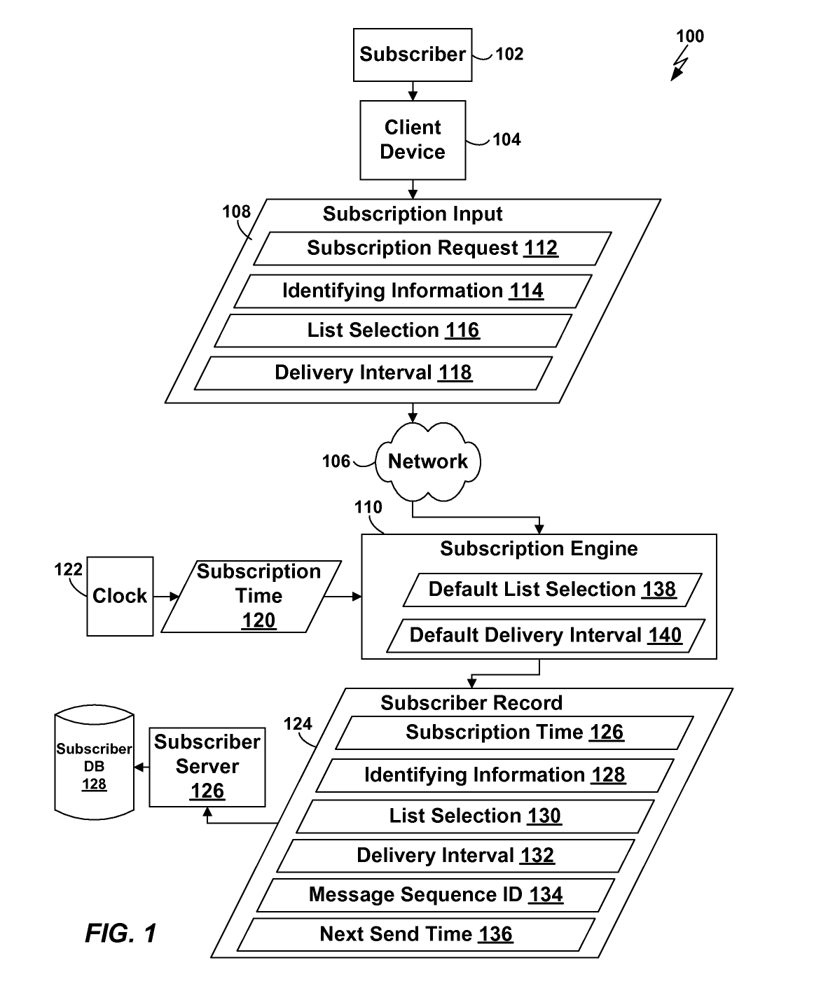

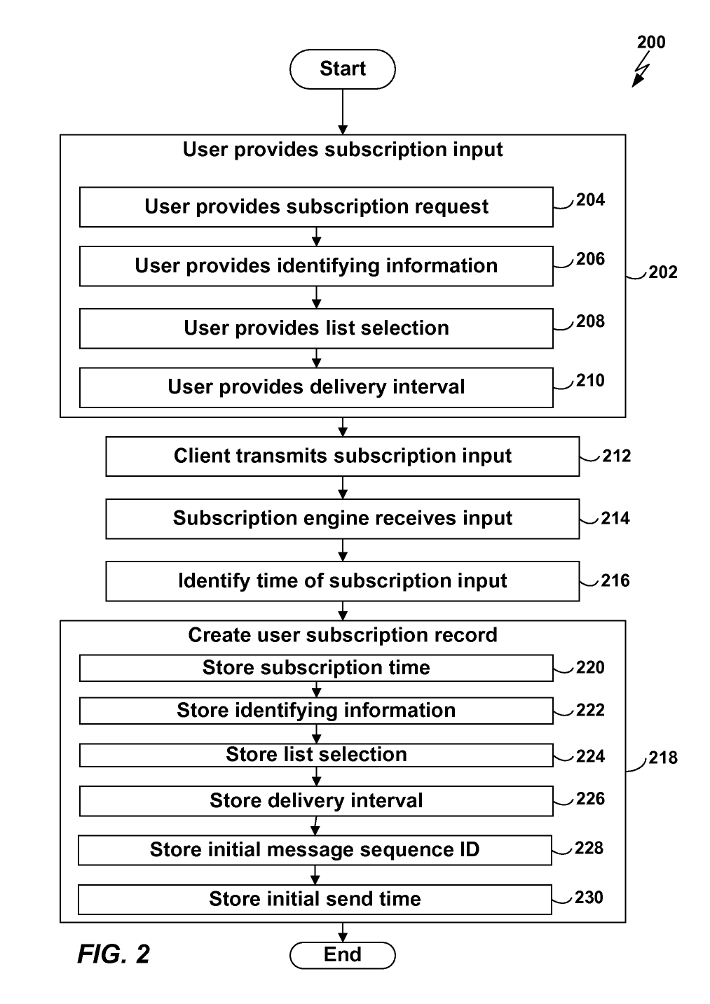

Referring to FIG. 1, a system 100 is shown for subscribing a user 102 to a sequence of electronically-delivered messages, such as a sequence of “tips” on a particular topic delivered by email over the Internet, according to one embodiment of the present invention. Referring to FIG. 2, a flowchart 200 is shown of a method 200 performed by the system 100 of FIG. 1 according to one embodiment of the present invention.

The user 102 (who may also be referred to herein as a “subscriber”) uses a client device 104, such as a desktop computer, cellular telephone, or personal digital assistant (PDA), to access a network 106, such as the Internet. In the following example, the user 102 desires to subscribe to a sequence of tips on a particular topic, such as golfing, gardening, investing, or any other topic of interest to the user 102. Note, however, that this is merely an example, and that the content of the messages to which the user 102 subscribes need not be “tips,” but rather may be any kind of content. Furthermore, the messages need not be delivered to the user 102 by email, but rather may be delivered to the user 102 by any communications mechanism.

In general, the user 102 provides input 108, over the network 106, to a subscription engine 110 (FIG. 2, step 202). The input 108 indicates that the user 102 desires to subscribe to a sequence of messages. The user 102 may provide the subscription input 108 in any of a variety of ways. For example, the user 102 may use a web browser (not shown) on the client device 104 to browse to a web page which provides a user interface through which the user 102 may select a message sequence to which to subscribe. Such a web page may, for example, display a set of lists and allow the user 102 to select one or more lists for subscription by clicking on checkboxes next to the list(s) to which the user 102 wishes to subscribe. Upon clicking on a “Subscribe” button, the client device 104 may generate and transmit the subscription input 108 to the subscription engine 110. Note, however, that this is merely one example of a mechanism for generating and transmitting the subscription input 108 to the subscription engine 110 and does not constitute a limitation of the present invention.

The subscription input 108 includes a subscription request 112 which indicates that the user 102 desires to subscribe to a message sequence maintained by the subscription engine 110 (FIG. 2, step 204). The subscription input 108 may include additional information. For example, the subscription input 108 may include information 114 identifying the user 102, such as the user's email address (step 206). The subscription input 108 may also include a list selection 116 identifying one or more lists (message sequences) to which the user 102 desires to subscribe (step 208). The subscription input 108 may also include a delivery interval 118, which indicates the amount of time that is to pass between each message that is sent to the user 102 after subscribing (step 210).

Note that these particular elements within the subscription input 108 are merely examples and do not constitute limitations of the present invention. Furthermore, although some or all of the subscription input 108 may be provided by the user 102, such as by providing input using a web browser, elements of the subscription input 108 may be generated by the client device 104. For example, the client device 104 may automatically extract the subscriber's email address 114 from a cookie or other data source stored on the client device 104. As another example, the client 104 may automatically generate the delivery interval 118 based on a default delivery interval which was previously configured at the client device 104. As yet another example, the subscriber's email address 114 need not be provided by the subscriber 102, or be provided through the client device 104. For example, an administrator may provide the subscriber's email address 114 to the subscriber server 126, or the subscriber server 126 may import the subscriber's email address 114 from a list, which may contain the email addresses of other users as well.

The client device 104 transmits the subscription input 108 over the network 106 (step 212), and the subscription engine 110 receives the subscription input 110 over the network 106 (step 214).

The subscription engine 110 identifies a “subscription time” 120 associated with the subscription input 108 (step 216). The subscription engine 110 may identify the subscription time 120 in any of a variety of ways. For example, the subscription engine 110 may include or otherwise have access to a clock 122, which the subscription engine 110 may query upon receiving the subscription input 108 to obtain a time that the subscription engine 110 treats as the user's subscription time. As another example, the client device 104 may identify the time of transmission of the subscription input 108 as the user's subscription time and include that subscription time within the subscription input 108 itself. The client 104 and/or subscription engine 110 may round off or otherwise modify the subscription time 120. These are merely examples of ways in which the user's subscription time may be identified and do not constitute limitations of the present invention.

The subscription engine 110 creates a subscription record 124a to store information about the user's subscription (step 218). Although in the following example it is assumed that the user 102 has subscribed to only one list (message sequence), the same techniques may be applied to multiple subscriptions by the same user, and to subscriptions my multiple users.

The subscription engine 110 may store a variety of information in the user's subscriber record 124a. For example, the subscription engine 110 may store the subscription time 120 in the subscriber record 124a as subscription time 126 (step 220). The subscription engine 110 may store some or all of the user's identifying information 114 (e.g., email address) in the subscriber record 124a as identifying information 128 (step 222). The subscription engine 110 may store a unique identifier of the list 116 to which the user 102 has subscribed as list identifier 130 (step 224). The subscription engine 110 may store the delivery interval 118 in the subscriber record 124a as delivery interval 132 (step 226).

As will be described in more detail below, the user 102 will receive messages in the subscribed list in sequence, beginning with the first message in the sequence. In the embodiment illustrated in FIG. 1, the system 100 keeps track of which message is to be transmitted to the user 102 next by storing a message sequence identifier 134 in the user's subscriber record 124a. When the subscription engine 110 creates the subscriber record 124a, the subscription engine 110 initializes the user's message sequence identifier 134 to a default value (e.g., zero or one), and stores that default value in the subscriber record 124a in element 134 (step 228).

In general, any scheme may be used to assign values to message sequence identifiers. For example, the message sequence identifier 134 may be assigned an initial value of zero, and then incremented (e.g., to 1, 2, 3, and so on) after each message in the sequence is transmitted to the user 102. Note, however, that this is merely an example of a numbering scheme that may be used to keep track of which message is to be sent next to the user 102, and does not constitute a limitation of the present invention.

The subscription engine 110 may also store an initial “send time” 136 in the user's subscriber record 124a (step 230), indicating the next time at which the user 102 is scheduled to receive a message from the subscribed list. The subscription engine 110 may, for example, initialize the next send time 136 to the subscription time 126 or to some default period (e.g., one day) after the subscription time 126.

Note that information other than the delivery interval 132 and next send time 136 may be stored in the subscriber record 124a to enable determining when the next message is scheduled to be transmitted to the user 102. For example, the subscriber record 124a may only include the next send time 136 field, but not the delivery interval field 132 if, for example, the same delivery interval is applied to all users.

Furthermore, the subscription engine 110 need not derive all of the subscriber record 124a from the subscription input 108. For example, as shown in FIG. 1, the subscription engine 110 may include a default list selection 138. If the subscription input 108 does not include list selection 116, then the subscription engine 110 may use the default list selection 138 to initialize the list identifier 130 in the subscriber record 124a. Similarly, the subscription engine 110 may include a default delivery interval 140. If the subscription input 108 does not include delivery interval 118, then the subscription engine 110 may use the default delivery interval 140 to initialize the delivery interval 132 in the subscriber record 124a.

Although only one subscriber 102 is shown in FIG. 1, the same techniques may be used to enable any number of subscribers to subscribe to lists of their choosing. A subscriber server 126 may maintain a subscriber database 128, which stores the subscriber record 124a for subscriber 102, and subscriber records for any number of other subscribers.

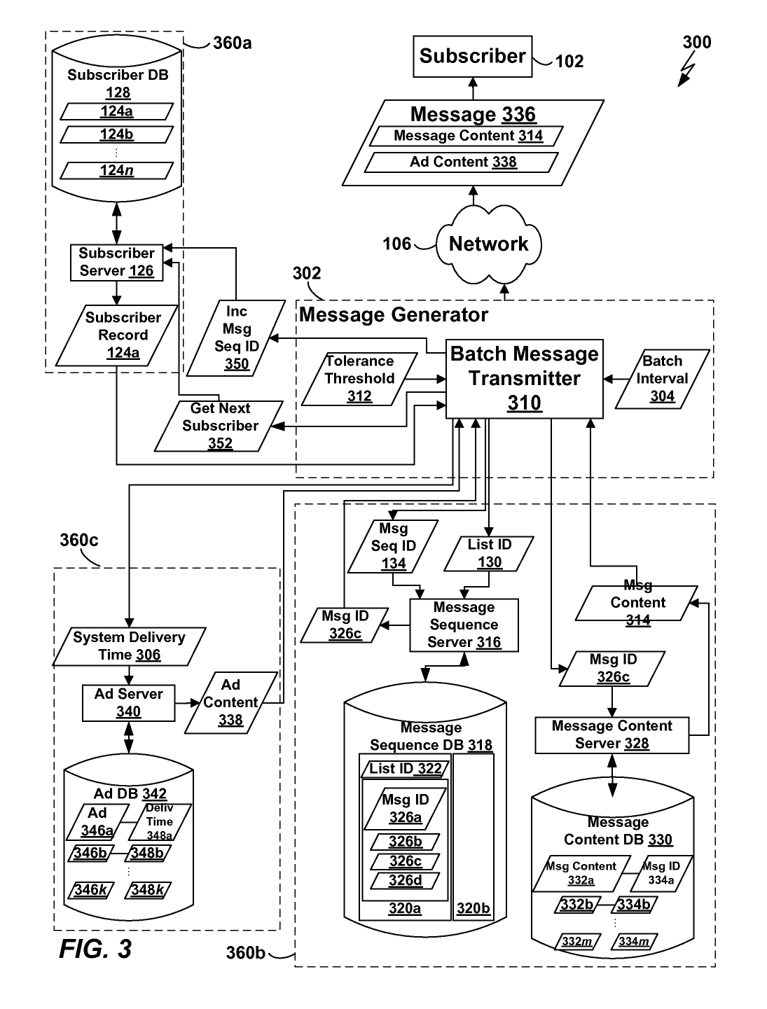

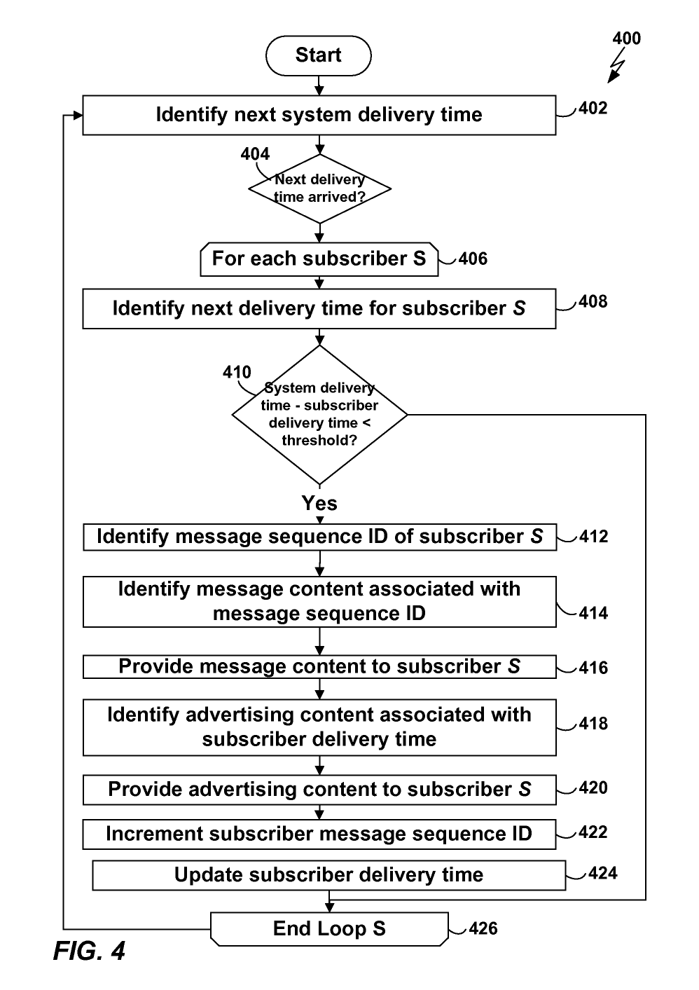

Once more or more subscribers have subscribed to their desired lists (message sequences), messages in those lists may be transmitted to each subscriber in sequence. Referring to FIG. 3, a dataflow diagram is shown of a system 300 for transmitting message sequences to subscribers according to one embodiment of the present invention. Referring to FIG. 4, a flowchart is shown of a method 400 performed by the system 300 of FIG. 3 according to one embodiment of the present invention.

As will be described in more detail below, the system 300 includes four primary portions: (1) a subscriber portion 360a for managing subscriber information; (2) a message content portion 360b for managing the contents and sequences of messages; (3) an advertising portion 360c for managing advertisements for inclusion in messages; and (4) a message generator 302 for generating and transmitting messages to subscribers. The system 300 may also include other portions (not shown), such as a tracking portion for tracking activity such as message bounce rates and open rates.

More specifically, the subscriber portion 360a includes subscriber database 128, which includes the subscriber record 124a for subscriber 102, as well as subscriber records 124b-n for other subscribers (not shown). Although certain elements the following example focus on how messages in a message sequence may be transmitted to the subscriber 102, the same techniques may be applied to transmitted messages to multiple subscribers.

As mentioned above, the system 300 includes message generator 302. In the following example, the message generator 302 generates messages within message sequences to which subscribers have subscribed, and transmits those messages over the network 106 to the subscribers. In the following example, the message generator 302 generates and transmits messages in batches. The message generator 302 transmits each batch at a predetermined time interval 304 (e.g., one hour) after the previous batch was transmitted. The messages within each batch contain those messages which subscribers are scheduled to receive at or around the time the batch is transmitted. This particular scheduling scheme, however, is merely an example and does not constitute a limitation of the present invention.

More specifically, the message generator 302 maintains a loop which begins with the message generator 302 identifying the next “system delivery time” 306 at which the message generator 302 is to transmit the next batch of messages to subscribers (FIG. 4, step 402). Note that the system delivery time 306 may be defined in any of a variety of ways, such as the time at which the next batch of messages is generated or the time at which the next batch of messages is transmitted.

The system delivery time 306 may be identified in any of a variety of ways. For example, the batch interval 304 may be added to the previous system delivery time 306 to identify the next system delivery time. The identified value may then be stored in the system delivery time 306 to update it.

The batch interval 304 may be any value, such as twenty seconds, one minute, one hour, or one day. Note that there need not be any relationship between the message generator's batch interval 304 and the delivery interval 132 for the subscriber 102. For example, the message generator's batch interval 304 may be one minute and the subscriber's delivery interval 132 may be one day, one week, or one month. Although not required, relatively short (e.g., one hour) batch intervals may be useful for ensuring that individual subscribers receive messages relatively close in time to their scheduled delivery time, even when the delivery times for different subscribers vary widely.

The message generator 302 determines whether the next system delivery time 306 has arrived (step 404). The message generator 302 may make this determination by, for example, comparing the next system delivery time 306 to a current time as indicated by a clock 308.

Once the next system delivery time 306 arrives, the message generator 302 enters into a loop over each subscriber S having a record in the subscriber database 128 to determine which of the subscribers is scheduled to receive a message at or around the next system delivery time 306 (step 406). Note, however, that the message generator 302 need not loop over all subscribers at once. For example, if the number of subscribers is large, the message generator 302 may divide the subscribers into groups and loop over different groups at different times to spread the load on the message generator 302. In the following example, however, it will be assumed that the message generator 302 loops over all subscribers for ease of explanation.

Furthermore, the message generator 302 need not wait until the next system delivery time 306 arrives before performing the processes described below. The message generator 302 may, for example, perform some or all of these processes before the system delivery time 306 arrives, in preparation for that time.

Now assume for purposes of example that the current subscriber S being processed by the message generator 302 is the subscriber 102, which has subscriber record 124a. The message generator 302 may identify the next delivery time 136 for subscriber 102 (step 408). The message generator 302 may identify the next delivery time 136 by, for example, transmitting a “get next subscriber record” message 352 to the subscriber server 126, in response to which the subscriber server 126 transmits the subscriber record 124a to the batch message transmitter 310. The batch message transmitter 310 may then read the delivery time 136 from the subscriber record 124.

The message generator 302 determines whether the current subscriber's next delivery time 136 is within a predetermined threshold 312 of the next system delivery time 306 (step 410). The threshold 312 may be static or dynamic and be assigned a value in any way. For example, the threshold 312 may be preconfigured to a value of 10 minutes. In such a case, if the next system delivery time 306 is 1:00 PM on Jan. 1, 2009 and the next delivery time 136 of subscriber 102 is 1:08 PM on Jan. 1, 2009, then the subscriber's next delivery time 136 will be determined to be within the threshold 312 of the next system delivery time 306, but not if the subscriber's next delivery time 136 is 1:12 PM on Jan. 1, 2009.

If the subscriber's next delivery time 136 is within the predetermined threshold 312 of the next system delivery time 306, a batch message transmitter 310 in the message generator 302 identifies the message sequence ID 134 of subscriber 102, such as by reading the message sequence ID 134 from the subscriber record 124a (step 412). Recall that the message sequence ID 134 represents an ordinal number indicating which message the subscriber 102 is scheduled to receive next. For example, if the message ID 134 is equal to or equivalent to seven, then the subscriber 102 is scheduled to receive the seventh message in the corresponding message sequence.

The batch message transmitter 310 identifies message content 314 associated with the subscriber's message sequence ID 134 (step 414). The batch message transmitter 310 may identify the message content 314 in any of a variety of ways. For example, recall that if multiple message sequences are available for subscription, the subscriber's subscriber record 124a may include a list ID 130 that identifies the list(s) to which the subscriber 102 is subscribed. Assume for purposes of the following example that the subscriber 102 is subscribed to exactly one list.

In this example, the batch message transmitter 310 may use the subscriber's list ID 130 and message sequence ID 134 to identify the message content 314 as follows. The batch message transmitter 310 transmits the list ID 130 and message sequence ID 134 to a message sequence server 316 which maintains a message sequence database 318 in message content portion 360b. In general, the message sequence database 318 maintains information about the sequence of messages in each available message sequence (list). In the particular example shown in FIG. 3, the message sequence database 318 includes message sequence records 320a-b corresponding to two message sequences, although the message sequence database 318 may include any number of message sequence records corresponding to any number of message sequences.

Assume for purposes of example that message sequence record 320a corresponds to the message sequence to which subscriber 102 is subscribed. The message sequence record 320a includes a list ID 322, which identifies the message sequence whose sequence information is contained within record 320a, and message sequence list 324. Message sequence list 324 contains a list of message identifiers 326a-d. The ordering of identifiers 326a-d in the list corresponds to the ordering of messages in the corresponding message sequence. Although only four message identifiers 326a-d are shown in FIG. 3, the list 324 may include any number of identifiers.

The message sequence list 324 may be stored in any manner that represents the sequence of message IDs 326a-d. For example, the message IDs 326a-d may be stored as a singly-linked or double-linked list. The sequence of message IDs 326a-d may be changed by re-ordering the list 324 using well-known techniques. Similarly, new message IDs may be added to the list 324, and existing message IDs may be removed from the list 324 using known techniques.

As will be described in more detail below, the message IDs 326a-d need not contain any message content. For example, recall that a message sequence may be a sequence of tips on a topic such as golfing. Each message in the sequence may contain content, such as text and/or graphics, representing the tip. The message IDs 326a-d in list 324 need not contain any such content. Instead, as will now be described in more detail, the message content may be stored separately from the message sequence list 324. As a result, the sequence of messages in a message sequence may be changed without requiring changes to the contents of the messages themselves.

Returning to step 414 of FIG. 4, the message sequence server 316 may receive the list ID 130 and message sequence ID 134 from the batch message transmitter 310. The message sequence server 316 may use the list ID 130 to select one of the message sequence lists 320a-b. For example, if the list ID 130 of the subscriber 102 matches the list ID 322 of list 320a, then the message sequence server 316 may select list 320a. The message sequence server 316 may then use the message sequence ID 134 to select one of the message IDs 326a-d in the selected list 320a. For example, if the message sequence ID 134 is equal to three, then the message sequence server 316 may select the third message ID in list 324, namely message ID 326c. Assume for purposes of the following discussion that message ID 326c is selected.

The message sequence server 316 returns the selected message ID 326c to the batch message transmitter 310. The batch message transmitter 310 passes the selected message ID 326c to a message content server 328 which maintains a database 330 of message content, such as the text of individual tips on a variety of topics. Although the contents of the database 330 may be organized in any of a variety of ways, for purposes of the present example all that is required is that each unit of message content be associated with a message ID, as shown in FIG. 3, in which a plurality of message contents 332a-m are associated with a corresponding plurality of message IDs 334a-m.

When the message content server 328 receives the message ID 326c from the batch message transmitter 310, the message content server 328 attempts to match the message ID 326c against the message IDs 334a-m in the database 330. If the message content server 328 finds a match, the message content server 328 returns the matching content back to the batch message transmitter 310 as message content 314. For example, if the value of message ID 326c is equal or equivalent to the value of message ID 334b, then the message content server 328 returns the corresponding message content 332b back to the batch message transmitter 310 as message content 314.

Once the batch message transmitter 310 receives the message content 314, the batch message transmitter 310 transmits the message content 314 to the subscriber 102 within a message 336 over the network 106 (step 416). The message 336 may, for example, be an email message transmitted to the subscriber 102 at the email address contained within the identifying information 128 in the subscriber record 124. The message 336 may, however, be another kind of message, such as an instant message, an SMS message, a voice message, or a message included within a web page. In this way, the subscriber 102 receives the message content 314 which the subscriber 102 is scheduled to receive at the subscriber's next delivery time 136.

The batch message transmitter 310 may transmit content to the subscriber 102 in addition to the message content 314. For example, the batch message transmitter 310 may transmit advertising content 338 to the subscriber 102 within the same message 336 as the message content 314.

The batch message transmitter 310 may identify the advertising content 338 in any of a variety of ways. For example, an advertising server 340 within advertising portion 360c may maintain a database 342 of advertising content, such as the text and/or graphics of individual advertisements. Although the contents of the advertising database 342 may be organized in any of a variety of ways, for purposes of the present example all that is required is that each unit of advertising content be associated with a delivery time, as shown in FIG. 3, in which a plurality of advertising contents 346a-k are associated with a corresponding plurality of delivery times 348a-k.

The batch message transmitter 310 may transmit the subscriber's next delivery time 136 (or the next system delivery time 306) to the advertising server 340. When the advertising server 340 receives the delivery time 136 from the batch message transmitter 310, the advertising server 340 selects the delivery time in the database 342 which is closest in time to the delivery time 136. The advertising server 340 returns the corresponding advertising content 338 back to the batch message transmitter 310. For example, if the delivery time 136 is closest to delivery time 348b, then the advertising server 340 returns the corresponding advertising content 346b back to the batch message transmitter 310 as advertising content 338.

Once the batch message transmitter 310 receives the advertising content 338, the batch message transmitter 310 transmits the advertising content 338 to the subscriber 102 within the message 336 over the network 106 (step 420). Note that the advertising content 338 (as transmitted to the message transmitter 310 and/or as provided within the message 336) may be static or dynamic. For example, the advertising content 338 may be the textual and graphical content of an advertisement, a static link to such content in the advertising database 342, or a dynamic link for generating or otherwise selecting advertising content when the link is subsequently activated.

The batch message transmitter 310 may format the message 336 in any of a variety of ways. For example, the batch message transmitter 310 may maintain a message template (not shown) which specifies fixed content and variable content for the message, using techniques that are well-known to those having ordinary skill in the art. Examples of fixed content include a heading of the message 336, which includes content such as the title and logo of a magazine associated with the message 336. The fixed content may also include style information, such as the display coordinates of the header and other elements, fonts, and colors to be used within the message 336. Examples of variable content include the message content 314, the advertising content 338, and the identifying information 128 (e.g., first name) of the subscriber 102. The batch message transmitter 310 may use such a template to insert (merge) the variable content into the message 336 in the manner dictated by the template. Such use of templates enables different instances of the message 336 to maintain a consistent look and feel even as the variable content of the message changes from message to message. The batch message transmitter 310 may use different templates, for example, for different lists.

Once the batch message transmitter 310 transmits the message 336 to the subscriber 102, the batch message transmitter 310 increments the subscriber's message sequence ID, such as by transmitting an increment message 350 to the subscriber server 126, which increments the message sequence ID 134 in the subscriber record 124 accordingly (step 422). For example, if the value of the message sequence ID 134 was previously equal to three, the subscriber server 126 may update that value to four. Note, however, that any numbering or labeling scheme may be used representing sequential values of message sequence IDs.

The batch message transmitter 310 also updates the next delivery time 136 of the subscriber 102 to indicate the time at which the next message in the sequence is to be transmitted to the subscriber (step 424). The batch message transmitter 310 may update the next delivery time 136 by, for example, adding the subscriber's delivery interval 132 to the subscriber's current delivery time 136 and storing the result as the subscriber's new next delivery time 136. The batch message transmitter 310 then repeats the steps described above for the remaining subscribers (step 426).

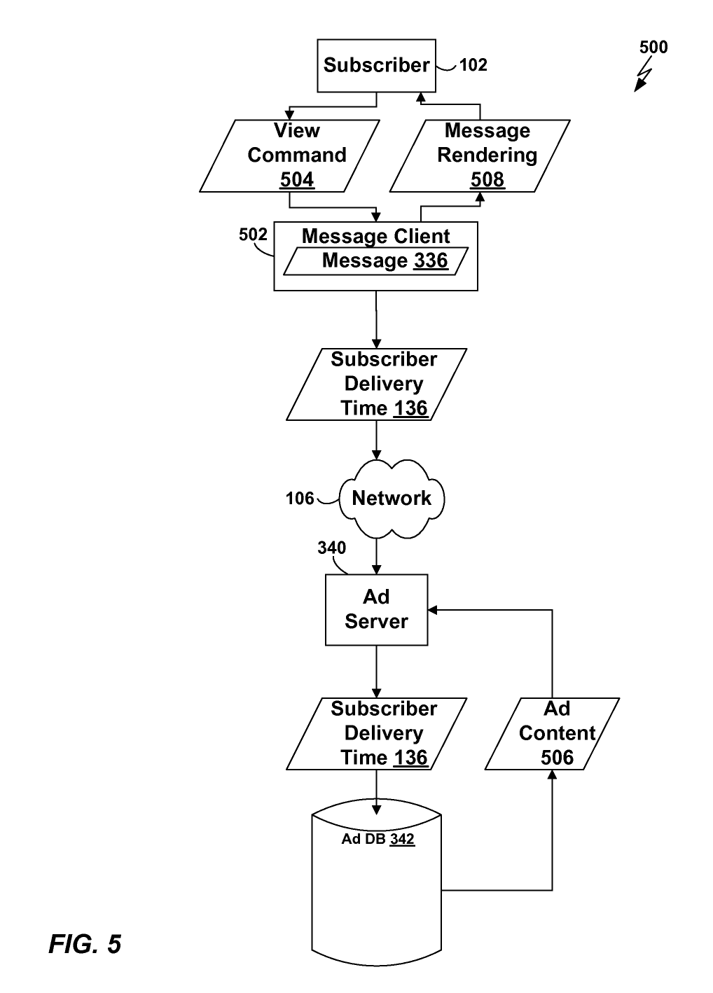

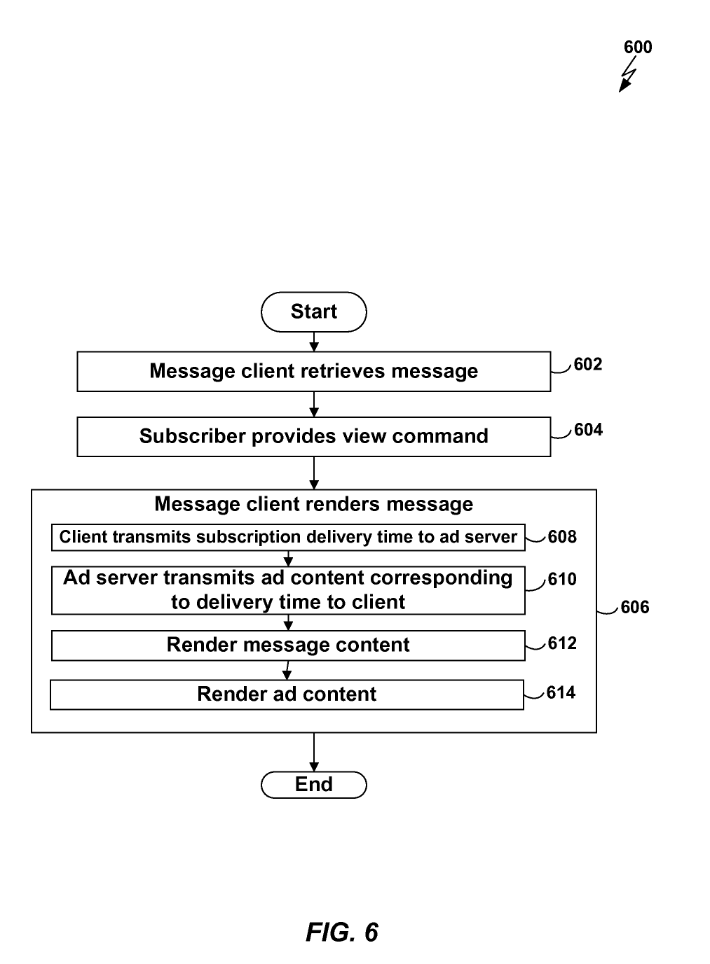

Once the subscriber 102 receives the message 336, the subscriber may view the message 336 at any time. FIG. 5 shows a dataflow diagram of a system 500 for displaying the message 336 to the subscriber 102 according to one embodiment of the present invention. FIG. 6 shows a flowchart of a method 600 performed by the system 500 according to one embodiment of the present invention.

Assume for purposes of the following discussion that the message 336 is an email message. An email client 502 downloads the message 336 and prompts the subscriber 102, such as by displaying the subject line of the message 336 to the user 102 (step 602). The subscriber 102 provides a view command 504 to the email client 502, such as by double-clicking on the message's subject line (step 604). In response, the email client 502 renders the message 336 on a display monitor or other output device to produce a rendering 508 of the message 336 (step 606).

As described above, the message content 314 and/or advertising content 338 of the message 336 may be static content, in which case viewing the message 336 will cause that static content (e.g., the text of a tip and an advertisement) to be displayed to the subscriber 102 within the rendering 508. Content within the message 336, such as the advertising content 338, may, however, be dynamic content, such as a link to a server-side script for generating or selecting an advertisement. In such a case, the act of rendering the message 336 may involve the email client 502 to transmit necessary information, such as the delivery time 136, to the advertising server 340 (step 608), in response to which the advertising server 340 may pull advertising content 506 corresponding to the delivery time 136 from the advertising database 342 and transmit the selected advertising content 338 back over the network 106 to the email client 502 (step 610). The email client 502 may then render both the (static) message content 502 (step 612) and the (dynamic) advertising content 506 (step 614) within the rendering 508 of the message 336. The email client 502 may transmit the delivery time 136 and/or other information to the advertising server using any of a variety of mechanisms, such as by encoding such information in a URL.

Embodiments of the present invention have a variety of advantages. For example, one benefit of embodiments of the present invention is that they provide a significant degree of flexibility in sequencing messages within a message list, changing that sequence, and adding messages to and deleting messages from such a list. Recall from FIG. 3 that the message content 330 is de-coupled from the message sequence information 318. As a result, units of content within the content database 330 can be expanded, modified, deleted, or added without affecting the ability of the message generator 302 to transmit message sequences to subscribers. Furthermore, the sequence (order) of messages in a message sequence may be modified easily merely by changing the sequence of message identifiers (e.g., message IDs 326a-d) in the corresponding list in database 318, without requiring changes to be made to the underlying content 330.

Furthermore, the sequence of messages in a particular message sequence need not be fixed before transmitting messages in that sequence to subscribers. In fact, sending a particular message in a message sequence to a subscriber does not require a list of messages in the sequence to exist at all, since the message to transmit to the subscriber may be selected dynamically at the time of message transmission. Rather, if the subscriber's message sequence ID (e.g., “tip number”) indicates that the subscriber is next scheduled to receive message number M, then all the system 300 needs is to be able to identify which message content is the Mth message content at that time. One example of a way for identifying such message content was described above with respect to FIGS. 3 and 4.

One consequence of such dynamic identification of message content is that performing actions such as changing the sequence of messages, adding messages, and deleting messages from a message sequence does not cause the system to break down. For example, imagine that User X receives tip #1 on Jan. 1, 2009. A new tip #1 is inserted at the beginning of the same list on Jan. 15, 2009. As a result, the old tip #1 has now become tip #2 without requiring any changes to the content or message ID of the old tip #1. If User Y subscribes to the same list on Feb. 1, 2009, the “tip #1” that User Y will receive at that time is the newly-inserted tip #1. A month later the “tip #2” that User Y receives will be the tip that User X had earlier received as “tip #1.” This flexibility in modifying the content delivered to users is facilitated by the dynamic identification of tip content at the time of tip transmission.

Another example of the flexibility of embodiments of the present invention is the ability to dynamically select and transmit advertisements associated with a particular delivery time. As described above, all subscribers who receive messages at a particular time (e.g., Jan. 1, 2009 at 12:00 pm) may receive the same advertising content within those messages, even if the message content (e.g., tips) contained within those messages varies from subscriber to subscriber. The advertising content associated with a particular time may then be identified dynamically and displayed to the subscribers whenever those users open their messages. For example, if the advertising content associated with Jan. 1, 2009 at 12:00 pm is transmitted within messages transmitted to fifty users, then that advertising content will be displayed to those fifty users when they open the messages, even if the messages contain different contents from each other (e.g., if different messages correspond to different message sequence identifiers), even if the users open the messages at later dates, and even if different users open their messages at different times from each other. This “chronologically-fixed, dynamic advertisement serving” provides advertisers with a greater degree of control over delivery of advertising content to users. Such a system also eliminates the need to insert the static (and often bandwidth-intensive) content of the advertisements within the messages themselves.

Alternatively, however, advertisements may be designated as being associated with particular message viewing dates, in which case the advertisement that is displayed to a user is selected based on the date/time at which the user views the message (e.g., opens the email). Such a scheme may be useful, for example, for advertisements that are only valid within a particular time window, such as “weekly specials.” To implement such a scheme, the advertising server 340 may associate a viewing time with advertising content in the advertising database 342. Then, when a subscriber views a message, the current viewing time may be provided to the advertising server 340, in response to which the advertising server 340 may retrieve the advertising content whose viewing time is closest to the current viewing time, and transmit that advertising content back to the subscriber.

Another benefit of embodiments of the present invention is that they enable each of a plurality of users to receive the sequence of messages at regular intervals over time, regardless of when those users subscribed to receive the messages. Assume, for example, that a list of golf tips is available for subscription by email. User X subscribes to the list of golf tips on Jan. 1, 2009 with a one-month tip interval. User Y subscribes to the same list of golf tips on Feb. 1, 2009 with a one-month tip interval. In this scenario, User X will receive golf tip #1 on Jan. 1, 2009. On Feb. 1, 2009, User X will receive golf tip #2, while User Y will receive golf tip #1. On Mar. 1, 2009, User X will receive golf tip #3, while User Y will receive golf tip #2, and so on.

One benefit of such a system is that each user receives all tips in the list, regardless of when the user subscribed to the list. In other words, a user does not “miss” any tips merely by subscribing to the list after the first tip in the list was sent to the first user. As a result, one benefit to users of such a system is that they are guaranteed to receive, over time, all tips to which they subscribe, thereby receiving the full benefit of such tips. One benefit to content providers and advertisers of such a system is that they are guaranteed that all subscribers will, over time, receive all content and advertising associated with tip lists.

Another benefit to users of such a system is that certain content may be most beneficial to receive in a predetermined sequence. For example, a list of top ten tips on golfing may begin with tips for beginners and progress to tips for experts. The expert tips may not make sense to someone who has not received the beginner tips. Embodiments of the present invention ensure that such tips are delivered to users in a logical sequence that provides maximum benefit to users. Similarly, such a system enables content providers and advertisers to deliver content to users in a predetermined sequence that is designed to maximize the impact on the recipients, such as by sequencing the content in accordance with a sales process.

One consequence of enabling different users to subscribe to the same list at different times and to receive messages in that list based on the subscription time of each user is that different users may receive different messages (e.g., tips) from the same list within the same time period. For example, in the example described above, the system transmits tip #2 to User X at the same time as the system transmits tip #1 to User Y. The techniques disclosed herein provide an efficient mechanism for keeping track of which tip is scheduled to be sent next to each user, and for transmitting messages to users efficiently even when different users receive different messages.

All of these features and benefits of embodiments of the present invention stand in contrast to conventional systems for sending email newsletters and other lists of messages to users, in which the same message is typically sent to each user at the same time. For example, when using a typical conventional email newsletter service to send the Jan. 1, 2009 edition of a newsletter to a list of subscribers, such a service will send the same Jan. 1, 2009 edition of the newsletter to all subscribers at the same time, regardless of when each subscriber subscribed to the newsletter, and regardless of which editions of the newsletter each subscriber has previously received. In contrast, embodiments of the present invention select the message content to deliver to each user based on when that user subscribed to the message list.

Another benefit of embodiments of the present invention is that they enable content providers to realize value from pre-existing content. For example, the contents 332a-m of the message content database 330 need not have been specifically created to be used as messages in a sequence of messages transmitted to users. Rather, for example, the contents 332a-m may be preexisting content created for a different purpose, such as articles from a golfing magazine originally distributed in print or in a static website. Such content, however, may easily be tagged with message IDs 334a-m to enable such existing content to be used as a sequence of messages transmitted to users in the manner described above. This technique enables the content owner (e.g., magazine publisher) to recognize significant value from pre-existing content which may otherwise be sitting on the shelf (either physically or on a web page) after having been delivered to a relatively small number of users only once. More specifically, the techniques disclosed herein enable such content to be repurposed so that it can be transmitted to an unlimited number of new users as they subscribe, thereby transforming “one-time use” content into content that can be re-used, and from which revenue can be generated, essentially an unlimited number of times.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Although in the examples described above, the message generator 302 identifies which subscribers are scheduled to receive messages in the next batch, the message generator 302 may identify such subscribers using techniques other than sweeping through or polling the subscriber database 128. For example, each of the subscriber records 124a-n may generate an event and transmit a message signaling that event to the message generator 302 when the corresponding subscriber delivery time has arrived.

Note that the “subscriber send time” 136 and the “system delivery time” 306 need not refer to the exact time at which the message 336 is sent to the subscriber 102. Rather, for example, the subscriber send time 136 and the system delivery time 306 may be any values which may be compared to each other to determine whether to include the subscriber 102 in the next batch of messages transmitted by the message generator 302. As a result, the subscriber send time 136 and system delivery time 306 may, in practice, differ significantly from the actual time at which the message 336 is sent to the subscriber. For example, the batch interval 304 may be relatively large, such as a day or a week, in which case the actual time at which the message 336 is transmitted may differ from the subscriber send time 136 and the system delivery time 306 by a day or a week.

Furthermore, the subscriber delivery time 136 and the system delivery time 306 may differ significantly from the time at which the process illustrated in FIG. 4 is performed. For example, the message generator 302 may perform part of the process 400 shown in FIG. 4 at 1:00 am on a Sunday for all messages batches to be sent in the next week in order to take advantage of low server processor load during off hours. The message generator 302 may then queue up multiple batches of messages for transmission at various times during the next week. In such a case, the subscriber send time 136 and the system delivery time 306 may differ from the time at which some of the process 400 is performed by up to a week.

The message content 314, advertising content 338, and any other “content” referred to herein may be static content (such as the text of a golfing tip, or a link to a static web page containing a golfing tip) or dynamic content (such as a link to a server-side script for generating an advertisement).

The techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

What is claimed is:

1. A computer-implemented method comprising:
(A) identifying a first system delivery time;
(B) identifying a first user delivery time associated with a first user; and
(C) if the first system delivery time is equivalent to the first user delivery time, then:
(1) identifying a first message sequence identifier associated with the first user;
(2) identifying first message content associated with a first message content sequence identifier having a value equivalent to a value of the first message sequence identifier; and
(3) providing the first message content to the first user.

2. The method of claim 1, wherein (C)(3) comprises transmitting to the user an email message containing the first message content.

3. The method of claim 1, wherein (C) further comprises:
(4) before (C)(3), identifying first advertising content associated with the first system delivery time; and
wherein (C)(3) comprises providing the first message content and the first identified advertising content to the first user.

4. The method of claim 1, wherein (C) further comprises:
(4) before (C)(3), identifying first advertising content associated with the first system delivery time; and
wherein (C)(3) comprises providing the first message content and an identifier of the first identified advertising content to the first user.

5. The method of claim 1, wherein (C) further comprises:
(4) before (C)(3), identifying first advertising content associated with the first message sequence identifier; and
wherein (C)(3) comprises providing the first message content and the first advertising content to the first user.

6. The method of claim 1, further comprising:
(D) identifying a second user delivery time associated with a second user; and
(E) if the first system delivery time is equivalent to the second user delivery time, then:
(1) identifying a second message sequence identifier associated with the second user;
(2) identifying second message content associated with a second message content sequence identifier having a value equivalent to a value of the second message sequence identifier; and
(3) providing the second message content to the second user.

7. The method of claim 1, wherein (B) comprises:
(B)(1) retrieving data representing the first user delivery time from a record associated with the first user.

8. The method of claim 1, wherein (B) comprises:
(B)(1) identifying a previous delivery time associated with the first user;
(B)(2) identifying a delivery interval associated with the first user; and
(B)(3) identifying the first user delivery time as a sum of the previous delivery time and the delivery interval.

9. The method of claim 1, wherein (C) further comprises:
(4) incrementing the value of the first message sequence identifier.

10. The method of claim 1, further comprising:
(D) identifying a second message sequence identifier associated with a second user, the second message sequence identifier having a value equivalent to the value of the first message sequence identifier;
(E) identifying second message content associated with a message sequence identifier having a value equivalent to the value of the first message sequence identifier, wherein the second message content differs from the first message content; and
(F) providing the second message content to the second user.

11. A computer-readable medium tangibly storing computer-executable instructions for:
(A) identifying a first system delivery time;
(B) identifying a first user delivery time associated with a first user; and
(C) if the first system delivery time is equivalent to the first user delivery time, then:
(1) identifying a first message sequence identifier associated with the first user;
(2) identifying first message content associated with a first message content sequence identifier having a value equivalent to a value of the first message sequence identifier; and
(3) providing the first message content to the first user.

12. The computer-readable medium of claim 11, wherein (C) (3) comprises transmitting to the user an email message containing the first message content.

13. The computer-readable medium of claim 11, wherein (C) further comprises:
(4) before (C) (3), identifying first advertising content associated with the first system delivery time; and
wherein (C) (3) comprises providing the first message content and the first identified advertising content to the first user.

14. The computer-readable medium of claim 11, wherein (C) further comprises:
(4) before (C) (3), identifying first advertising content associated with the first system delivery time; and
wherein (C) (3) comprises providing the first message content and an identifier of the first identified advertising content to the first user.

15. The computer-readable medium of claim 11, wherein (C) further comprises:
(5) before (C) (3), identifying first advertising content associated with the first message sequence identifier; and
wherein (C) (3) comprises providing the first message content and the first advertising content to the first user.

16. The computer-readable medium of claim 11, further comprising:
(D) identifying a second user delivery time associated with a second user; and
(E) if the first system delivery time is equivalent to the second user delivery time, then:
(5) identifying a second message sequence identifier associated with the second user;
(6) identifying second message content associated with a second message content sequence identifier having a value equivalent to a value of the second message sequence identifier; and
(7) providing the second message content to the second user.

17. The computer-readable medium of claim 11, wherein (B) comprises:
(B)(1) retrieving data representing the first user delivery time from a record associated with the first user.

18. The computer-readable medium of claim 11, wherein (B) comprises:
(B)(1) identifying a previous delivery time associated with the first user;
(B)(2) identifying a delivery interval associated with the first user; and
(B)(3) identifying the first user delivery time as a sum of the previous delivery time and the delivery interval.

19. The computer-readable medium of claim 11, wherein (C) further comprises:
(8) incrementing the value of the first message sequence identifier.

20. The computer-readable medium of claim 11, further comprising:
(D) identifying a second message sequence identifier associated with a second user, the second message sequence identifier having a value equivalent to the value of the first message sequence identifier;
(E) identifying second message content associated with a message sequence identifier having a value equivalent to the value of the first message sequence identifier, wherein the second message content differs from the first message content; and
(F) providing the second message content to the second user.
